(19) United States
(12) Patent Application Publication
(10) Pub. No.: US 2004/0026930 A1
(43) Pub. Date: Feb. 12, 2004

(54) Wind powered recharger for trolling motor batteries

(76) Inventor: Danny R. Baggett, Clarksville, TN (US)

Correspondence Address: Richard C. Litman, LITMAN LAW OFFICES, LTD., P.O. Box 15035, Arlington, VA, 22215, US

(21) Appl. No.: 10/618,304

(22) Filed: Jul. 14, 2003

Related U.S. Application Data
(60) Provisional application No. 60/402,539, filed on Aug. 12, 2002.

(51) Int. Cl. H02P 9/04

(52) U.S. Cl. 290/54

(57) ABSTRACT

A wind powered recharger for charging trolling motor batteries. The charger has a scoop or cowling mounted on top of the outboard motor. Air is forced into the front of the scoop and sent out an exhaust at the rear of the scoop. Inside the scoop is a four-blade fan attached to an alternator. The movement of air through the scoop causes the four-blade fan and alternator to turn. The scoop, fan and alternator are mounted on a base plate, attached to the top cover of an outboard motor of a boat. The plate can be a two-piece plate for mounting on an outboard motor cover. The plate can provide portability, that is detaching and reattaching of the charger at a different locations. The alternator is connected to the batteries via an inline electrical coupling that is easily attached and detached.

### CROSS-REFERENCE TO RELATED APPLICATION

This application claims the benefit of U.S. Provisional Patent Application Serial No. 60/402,539, filed Aug. 12, 2002.

### BACKGROUND OF THE INVENTION

1. Field of the Invention

The present invention relates to a wind powered mechanism to recharge a bank of batteries used for powering an electric trolling motor on a boat, and more particularly to a wind powered recharger having a cowling, a fan blade, and an electric alternator all in one unit, which can be mounted close to the bank of batteries and/or electric motor.

2. Description of Related Art

Typically, electric trolling motors for boats use a battery or bank of batteries, which are charged in various ways. Most commonly they are charged by a charger powered by a building or house AC power line using a temporary connection. This recharge process requires preparation and time before leaving the building or house. Therefore, operation time for the trolling motor is limited to the first charge. The operation time for the trolling motor is also limited, when a fossil fueled boat motor is used to charge the batteries during transits across the body of water. The amount of time for the trolling motor operation is also limited when solar panels are used to charge the batteries during sunlight conditions, because they provide too little charge current. Too often a person fishing will use a trolling motor for extended times at a plurality of different fishing locations on the same body of water in the same day, and none of the recharge methods mentioned above address this usage of the trolling motor batteries.

A variety of battery charging systems have been proposed to solve some of the problems mentioned above. In a few examples, U.S. Pat. No. 3,878,913 issued Apr. 22, 1975 to Loints et al.; U.S. Pat. No. 3,713,503 issued Jan. 30, 1973 to Haan; U.S. Pat. No. 3,621,930 issued Nov. 23, 1971 to Dutchak; U.S. Pat. No. 3,444,946 issued May 20, 1966 to Waterbury; U.S. Pat. No. 1,903,307 issued Apr. 4, 1933 to Gillio; U.S. Pat. No. 4,314,160 issued Feb. 2, 1982 to Boodman et al.; U.S. Pat. No. 5,287,004 issued Jan. 15, 1994 to Finley; U.S. Pat. No. 6,138,781, issued Oct. 31, 2000 to Hakala; U.S. Pat. No. 5,917,304, issued Jun. 29, 1999 to Bird; U.S. Pat. No. 5,680,032, issued Oct. 21, 1997 to Pena; and U.S. Pat. No. 4,141,425, issued Feb. 27, 1979 to Treat disclose a bank of batteries that are recharged by an impeller driven alternator turned by air, which is mounted within ductwork of a vehicle. Problems with these wind powered solutions are the weight and loss of wind speed due to friction when they use the extra long ductwork or tunnels. These wind powered solutions are permanently mounted. Also, these wind powered solutions rely on secondary sources of power. In other examples, U.S. Pat. No. 4,324,985, issued Apr. 13, 1982 to Oman and U.S. Pat. No. 4,718,822 issued Jan. 12, 1988 to Riezinstein disclose a wind turbine for charging batteries used on a sailboat pivoted so that it can catch the wind as the sailboat changes direction. Problems with these solutions are the springs and other mechanisms needed to counteract high winds. Another problem with these solutions are no guarantee that they will be pointed in the direction of the wind to generate electricity, when powered by another engine or towed on a trailer.

In addition, U.S. Pat. No. 6,192,821 issued Feb. 27, 2001 to Morales et al.; U.S. Pat. No. 5,896,022 issued Apr. 20, 1999 to Jacobs, Sr.; U.S. Pat. No. 5,483,144 issued Jan. 9, 1996 to Marek; U.S. Pat. No. 5,583,414 issued Dec. 10, 1999 to Lawrence; U.S. Pat. No. 5,371,454 issued Dec. 6, 1994 to Marek; U.S. Patent No. U.S. Pat. No. 5,041,029 issued Aug. 20, 1991 to Kulpa; and U.S. Pat. No. 1,832,808 issued Nov. 17, 1931 to Grier disclose other battery charging systems or trolling motor systems.

It would be desirable to have a wind powered battery charger mounted in a simple and easy manner external to an existing vehicle structure without extra mechanisms to direct it in the direction of the wind. Also, it would be desirable to have a wind powered battery charger that does not need or use a long duct or wind tunnel and mounts close to a bank of batteries and provides a charge rate to fully charge a bank of batteries before they are needed. In addition, it would be desirable, to have a wind powered battery charge in which the fan to catch the wind is near the opening of a scoop and is directly coupled to the alternator.

None of the above inventions and patents, taken either singly or in combination, is seen to describe the instant invention as claimed.

### SUMMARY OF THE INVENTION

The invention is a wind powered recharger for charging trolling motor batteries in a boat. The charging of the batteries occurs while the boat is in transit or towed to a body of water, while the boat is in motion on a body of water under the power of a fossil fueled engine (outboard motor), or while the boat is in motion on a body of water under the power of a trolling motor (an electric motor). The charger has a scoop or cowling mounted on top of the outboard motor. Air is forced into an opening at the front of the scoop and sent out an exhaust at the rear of the scoop. Mounted inside the scoop is a four-blade fan attached to an alternator. The movement of air through the scoop causes the four-blade fan and alternator to turn. The scoop, fan and alternator are mounted on a base plate, which is attached to the top cover of an outboard motor of a boat. The plate can be a two-piece plate for mounting on an outboard motor cover that opens by splitting down the center of the motor cover. The plate can provide a means for portability. The plate design can provide detaching and reattaching of the charger at different locations. The alternator within the scoop is connected to the batteries via an inline electrical coupling that is easily attached and detached.

Accordingly, it is a principal object of the invention to provide a wind powered charger for charging a bank of trolling motor batteries on a boat, which has charge rate large enough to fully charge the bank of batteries while the boat is in transit or being towed on a trailer to a body of water.

It is another object of the invention to provide a wind powered charger for batteries that is small and does not need long or complicated ductwork or wind tunnels.

It is further object of the invention to provide a wind powered charger for batteries which mounts externally on an existing surface of the boat specifically on the top cover of an outboard fossil fueled motor.

It is another object of the invention to provide a wind powered charger for batteries in which the fan blade is directly connected to the alternator.

Still another object of the invention is to provide a wind powered charger for batteries which mounts in a location that is close to the bank of batteries such as the top cover of an outboard fossil fueled motor.

It is another object of the invention to provide a wind powered charger for batteries which mounts in a location that does not need mechanisms to keep it in the direction of the wind.

It is another object of the invention to provide a wind powered charger for batteries having fan blades near the opening of a scoop or ductwork.

Still another object of the invention is to provide a wind powered charger for batteries, which easily and quickly mounts and unmounts on the top cover of an outboard fossil fueled motor.

Still another object of the invention is to provide a wind powered charger for batteries, which easily and quickly mounts and unmounts on the top cover of an outboard fossil fuel motor, which opens by splitting at the center top of the cover.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specifications and drawings.

### BRIEF DESCRIPTION OF THE DRAWINGS

FIG. 1 is an environmental, elevational view of a wind powered recharger for trolling motor batteries according to the present invention.

FIG. 2 is a perspective view of a wind powered recharger of the present invention.

FIG. 3 is an exploded perspective view of a wind powered recharger of the present invention.

FIG. 4 is a top view of a bottom two piece base plate that mounts on the motor cover.

FIG. 5 is a top view of a single piece base plate that mounts on the motor cover.

FIG. 6 is a top view of the cowling or scoop that mounts on the motor cover.

FIG. 7 is a perspective view of all the parts of a wind powered recharger of the present invention inside the cowling.

FIG. 8 is a perspective view of an additional embodiment of the present invention having a protective screen disposed on the front of the scoop.

Similar reference characters denote corresponding features consistently throughout the attached drawings.

### DETAILED DESCRIPTION OF THE PREFERRED EMBODIMENTS

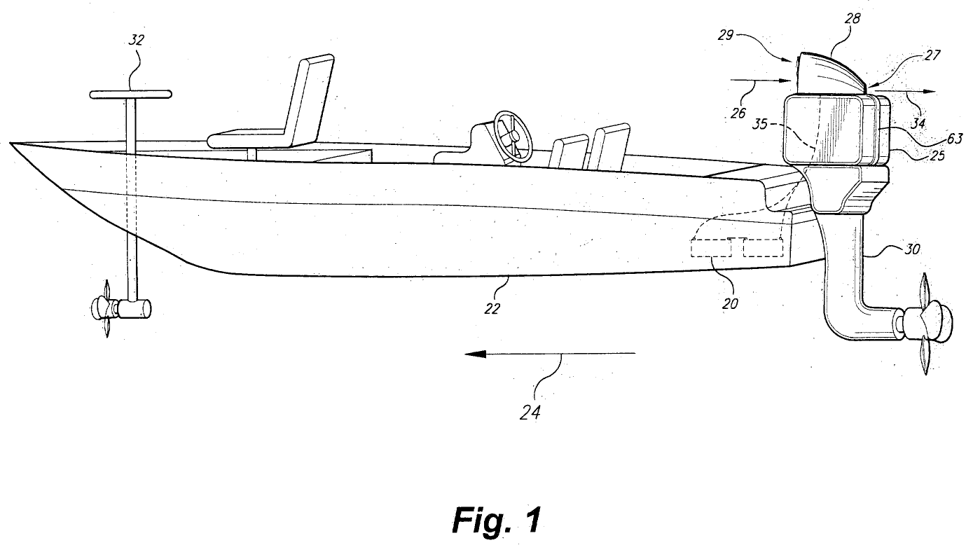

As shown in FIG. 1, the present invention is a wind powered charger 28 mounted on the top cover 25 of a fossil fueled outboard motor 30, which is mounted on a boat 22. The wind powered charger 28 has a fan and an alternator built inside the cowling or scoop of the charger 28. The alternator is connected by cable 35 to the batteries 20 inside the boat on its deck near the fossil fueled outboard motor 30. An inline electrical connector (not shown) is included in cable 35 to allow the wind powered charger 28 to be disconnected from the batteries 20, when removing the top cover 25 of the motor 30 is necessary. Batteries 20 supply power primarily to the trolling motor 32. The direction of movement 24 of the boat 22 causes air to flow in the direction 26 to the input 29 of the wind charger 28 and exit at the exhaust 27 in the direction 34. This movement occurs while the boat 22 is towed over land to a body of water or while the boat 22 transits from location to location across a body water under power of the trolling motor 32 or while the boat 22 transits from location to location across a body water under power of the outboard motor 30. The whole wind powered charger 28, while in motion or operation, is permanently mounted in the direction of the wind.

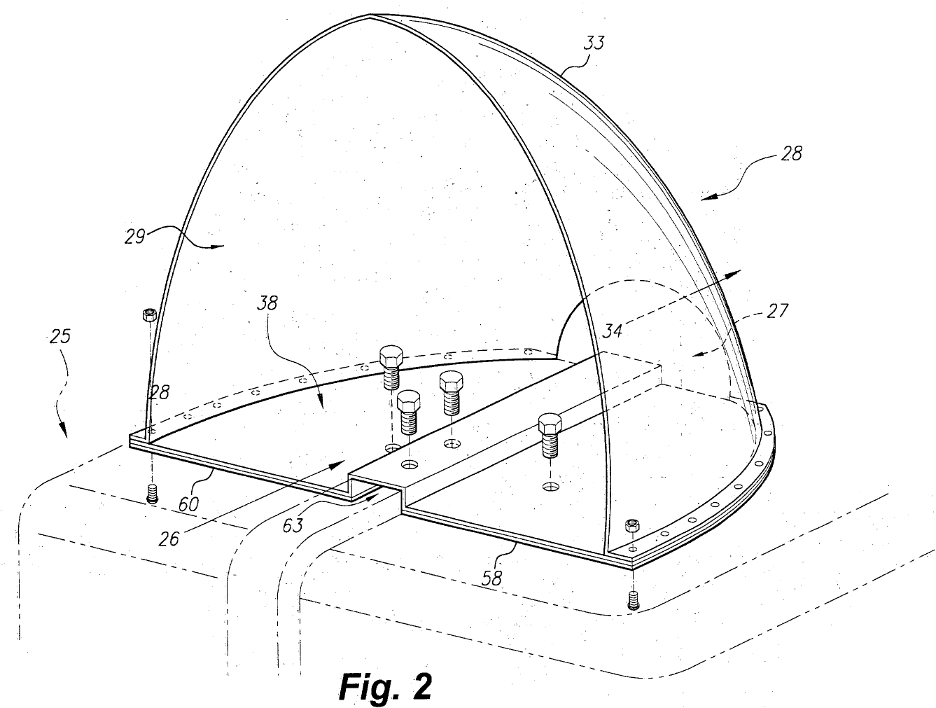

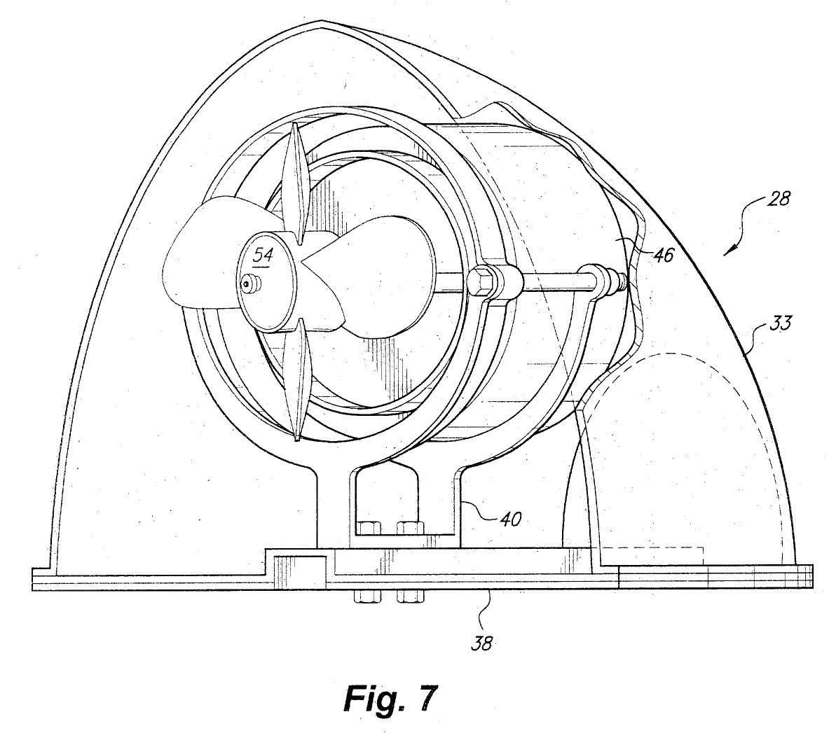

As seen in FIG. 2, the wind powered charger 28 has a front air inlet 29 facing the wind direction 26 and rear exhaust port 27 exhausting air in direction 34. A bottom or single base plate 38 attaches the top scoop surface 33 of the charger 28 to the top of the motor cover 25. The typical motor cover 25 does not have a ridge 63, in which case the motor cover 25 is flat or smooth, the single plate 38 is flat and plates 58 and 60 shown in FIG. 2 are not needed. When a user requires access to the engine inside the typical one piece motor cover 25, he can remove the whole one piece motor cover 25 with the wind powered charge unit 28 still attached to the one piece motor cover 25. The top surface 33 has a scoop like three-dimensional shape as shown that decreases in height from front 29 (where wind enters) to back 27 (where wind exits). Exhaust opening 27 is smaller than front air inlet 29. In FIG. 2, the one piece bottom plate 38 can be all one flat piece for use with typical outboard motor covers that are smooth or flat on top and are removed as one piece. With the typical one piece motor cover there is no need to remove the wind charger when access is needed to the engine inside the cover. The one piece bottom plate 38 has shape as shown decreasing from front to back and matches the bottom shape of the scoop 33 as shown in FIG. 7. The front inlet 29 faces into the wind in direction 26 and the exhaust port 27 exhausts air in the direction 34.

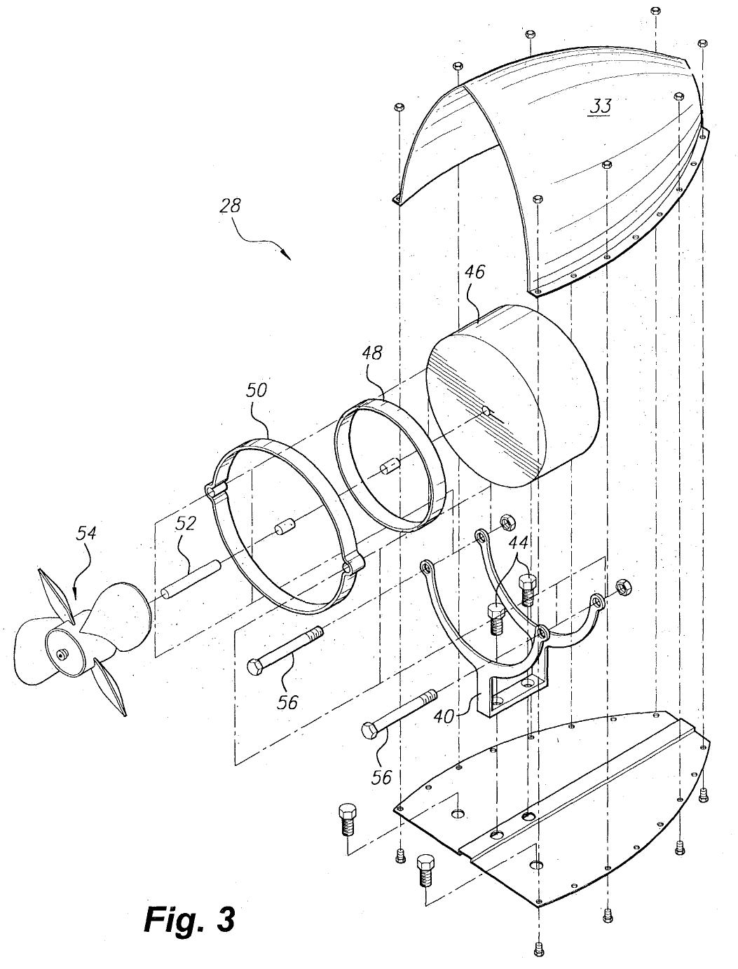

As shown in FIG. 3, the wind powered charger 28 has a scoop 33 like shape that decreases in height from front (where wind enters) to back (where wind exits) as shown. A four-blade fan 54 is mounted on the shaft 52. Shaft 52 is the shaft of the alternator 46. Thus, the fan 54 directly drives the alternator 46. Bushing 50 and alternator front housing 48 together bolt on with bolts 56 to bracket 40, which are bolted with bolts 44 on to plate 38. The bushing 50 and the front housing 48 secure the alternator main body 46 to the bracket 40. With regard to FIGS. 3 and 7, the positioning of the bracket 40 is such that the fan 54 is within two inches of the front air inlet 29 (as shown in FIG. 2) of the scoop 33 and positioned in the center of the front air inlet 29 both vertically and horizontally. In other words, the fan 54 is very close to the opening of the scoop 33. Some or all of the bolt holes 39 also bolt the scoop 33 onto the plate 38. After the scoop 33 is bolted onto the plate 38, the plate 38 has other bolt holes to accommodate bolting the plate 38 onto the motor cover 25. The plate 38, also, provides the bolt holes for the bracket 40 for the attachment of the alternator 46 and fan 54.

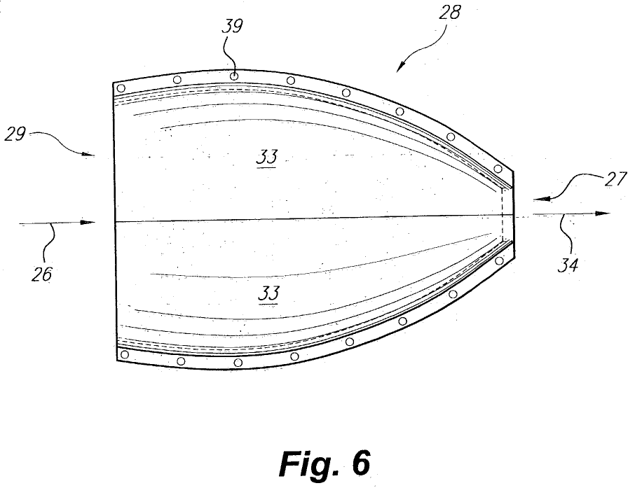

FIG. 6 shows a top view of the wind powered charger 28 which mostly shows the scoop or cowling 33. This view shows the bolt holes 39 along a flat portion of the cowling or scoop that mount the cowling or scoop to the plate 38 as shown in FIG. 2. In FIG. 6, the scoop 33 has a shape as shown larger at the front input 29 and smaller at the rear exhaust 27.

FIG. 7 shows the fan 54, alternator 46 and bracket 40 are all coupled together and mounted on the bottom plate 38 inside the scoop 33 as the wind powered charger 28 would appear if not mounted on top of the outboard motor 30 or other external surface. The scoop 33 can be made of fiberglass or extruded plastic and bolts on to plate 38.

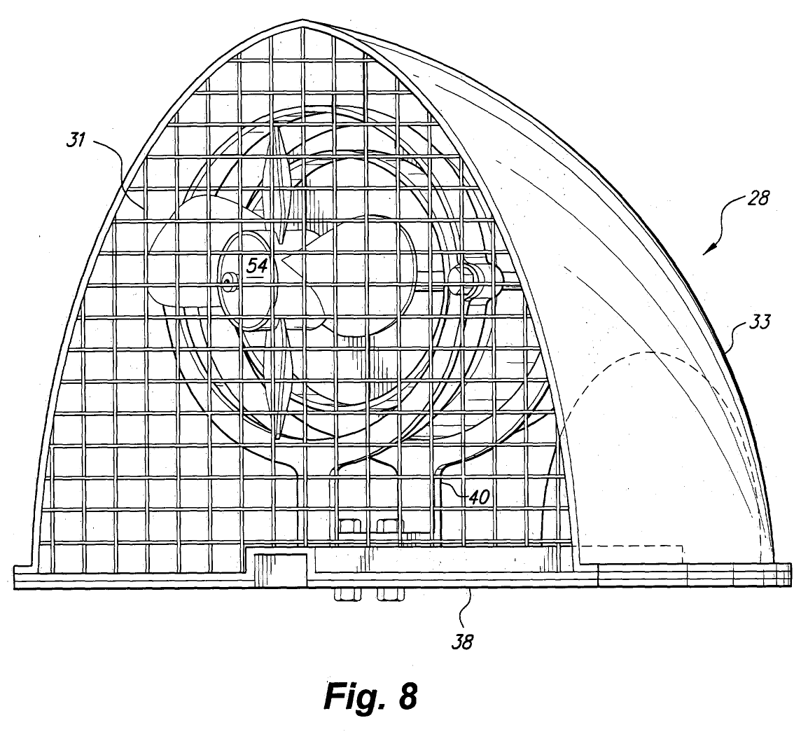

FIG. 8 shows an additional embodiment of the present invention having a screen 31 or louvers covering the front of the scoop 33. The screen 31 protects the fan 54 and prevents anyone from coming into contact with the blades of the fan 54. The openings in the screen 31 are large enough to not significantly slow the air flow that pushes the fan 54.

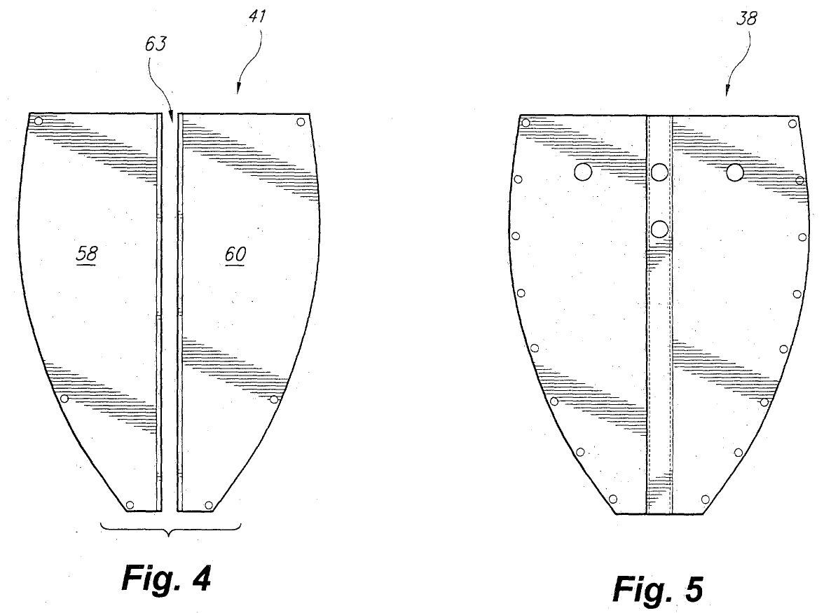

FIG. 4 shows a two-piece adaptor for the bottom plate 38 designed for mounting the wind charger 28 on a alternate two piece top cover 25 of an outboard motor 30, which opens by splitting down the center ridge 63 of the alternate motor cover 25 as shown in FIGS. 1 and 2. The bottom plate 41 shown in Fig. 4 mounts on the cover as two separate pieces 58 and 60 on either side of the center ridge 63, as shown in FIGS. 1 and 2, where the opening of the two piece top cover 25 is located. As shown in FIG. 4, the two bottom pieces 58 and 60 provide bolt holes to match the upper plate 38 as shown in FIGS. 2, 4 and 5. Bolts mount the upper plate 38 to the bottom plates 58 and 60 on the top portion of the motor cover 25. FIG. 2 also shows how the two bottom piece plates 58 and 60 are mounted on opposite sides of the center ridge 63 on the alternate motor cover 25. As shown in FIGS. 2 and 5, the single piece base plate 38 is modified to have a hump to match the center ridge 63. In FIG. 2, the top scoop 33 attaches to the modified single piece plate 38 with bolts in some or all of the holes. The wind powered charger 28 is one whole unit that mounts on the two bottom pieces 58 and 60. The modified single piece plate 38 of wind powered charger is mounted with other bolts to the bottom plates 58 and 60. When a user requires access to the engine inside the alternate two piece motor cover 25, he can easily and quickly remove the wind charger 28 by unbolting only the bolts holding the modified single piece plate 38 to each of the two piece plates 58 and 60, while bolts holding the scoop 33 and the bracket 40 in FIG. 3 remain bolted to the modified single piece plate 38. The wind powered charger 28 remains as a whole unit when removed from the two piece plates 58 and 60 used on the motor cover 25 having an opening at center ridge 63.

In operation as shown in FIGS. 1 and 7, when the boat 22 is towed by a land vehicle to a body of water, the boat 22 will be moving in the direction 24. Wind in the direction 26 will be forced into the cowling or scoop 33 of the charger 28 at its inlet 29. This wind will catch and turn the fan 54. The fan 54 will turn the alternator 46. The alternator 46 provides charge to the batteries 20. The same operation occurs when the boat 22 is in transit between different fishing spots on the body of water when the outboard motor 30 or trolling motor 32 is used. The slower amount of motion on a body of water with either the outboard motor 30 or the trolling motor 32 will result in a lesser charge of the batteries 20 than when the boat 22 is towed on a trailer over land.

The alternator 46 is an ordinary alternator, which is used to charge a battery in a car or a boat by a fossil fueled engine. Typically, the batteries 20 provide the field coil current to the alternator 46. The alternator 46 includes a typical voltage regulator, which controls the charging and field coil currents. In certain preferred embodiments of the present invention the alternator 46 is a 74 amp one wire, self energizing alternator. This particular alternator improves efficiency and is adapted for charging up to three batteries at one time.

While the boat 22 is being towed over land, the batteries 20 receive a full charge or more. While the boat 22 is powered by the fossil fueled outboard motor 30 and moving across the body of water, the batteries 20 receive less than a full charge. When the boat 22 is powered by the trolling motor 32 and moving across the body of water, (which uses the power of the batteries to be charged), the batteries 20 receive an even smaller charge or maintenance charge. These charge rates, also, vary with the ambient winds and wind directions as well. The alternator's included voltage regulator prevents over charge, under charge or discharge of the batteries 20 in all charging situations.

It is to be understood that the present invention is not limited to the embodiments described above, but encompasses any and all embodiments within the scope of the following claims.

I claim:

1. A wind powered charging system for batteries in a water vehicle, comprising:
a cowling adapted for attachment to an external surface of said water vehicle;
said cowling having a front input port for incoming air and a rear output port for outgoing air;
a mounting plate providing a means for attaching said cowling to said external surface of said water vehicle;
a fan blade adapted for attachment to an alternator;
said alternator and fan blade adapted for attachment to said plate within said cowling; and
a front of said fan blade facing said input port;
wherein when air enters said input port and exits through said output port said fan will turn and said fan will turn said alternator which will generate electric current to charge said batteries.

2. The wind powered charging system for batteries in a water vehicle according to claim 1, wherein said cowling is attached to an outboard motor disposed on said water vehicle.

3. The wind powered charging system for batteries in a water vehicle according to claim 1, wherein said alternator is connected to said batteries by a cable.

4. The wind powered charging system for batteries in a water vehicle according to claim 1, wherein said mounting plate is selected from the group consisting of single piece plates for mounting to flat motor covers and multi piece plates for mounting to motor covers having a center ridge.

5. The wind powered charging system for batteries in a water vehicle according to claim 1, wherein said cowling comprises a top portion that decreases in height from said front input port to said rear output port of said cowling so that said input port is larger than said output port.

6. The wind powered charging system for batteries in a water vehicle according to claim 1, wherein said mounting plate comprises a shape that decreases in size from front to back and is equivalent to the bottom surface of said cowling.

7. The wind powered charging system for batteries in a water vehicle according to claim 1, wherein said front input port faces in the direction of the wind and said rear output port exhausts air out of the rear of said cowling.

8. The wind powered charging system for batteries in a water vehicle according to claim 1, wherein said fan blade is mounted to an alternator shaft that extends from said alternator, wherein said fan blade directly drives said alternator.

9. The wind powered charging system for batteries in a water vehicle according to claim 1, wherein said fan blade and said alternator are attached to said mounting plate by a mounting bracket which is directly bolted to said mounting plate, wherein said alternator is secured to said mounting bracket by a bushing and an alternator housing.

10. The wind powered charging system for batteries in a water vehicle according to claim 1, wherein said fan blade is positioned directly in the center of said front input port of said cowling.

11. The wind powered charging system for batteries in a water vehicle according to claim 1, wherein said cowling further comprises a flat outer mounting portion having a plurality of bolt holes for mounting said cowling to said mounting plate.

12. The wind powered charging system for batteries in a water vehicle according to claim 1, further comprising a screen covering the front input port of said cowling to protect said fan blade.

13. The wind powered charging system for batteries in a water vehicle according to claim 1, wherein said cowling is made from a material selected from the group consisting of fiberglass and extruded plastic.

14. The wind powered charging system for batteries in a water vehicle according to claim 1, wherein said alternator is a 74 amp one wire, self energizing alternator that is adapted to charge three or less batteries at one time.
